(19) United States
(12) Patent Application Publication
(10) Pub. No.: US 2024/0287850 A1
(43) Pub. Date: Aug. 29, 2024

(54) THERMAL INSULATION MEMBER AND THERMAL INSULATION WINDOW

(71) Applicant: Thermalytica, Inc., Tsukuba-shi, Ibaraki (JP)

(72) Inventors: Rudder WU, Ibaraki (JP); Kuan-I LEE, Ibaraki (JP); Kazuo KONUMA, Tokyo (JP)

(21) Appl. No.: 18/572,778

(22) PCT Filed: Mar. 31, 2022
(86) PCT No.: PCT/JP2022/016963

§ 371 Date: Dec. 20, 2023

(51) Int. Cl. E06B 3/67; E06B 3/663

(52) U.S. Cl. CPC E06B 3/6715; E06B 3/663

(57) ABSTRACT

A thermal insulation window according to the present invention includes a pair of panels, a space between the panels, a thermal insulation material to fill the space with; and a mechanism capable of filling the space with the thermal insulation material and removing the thermal insulation material from the space. The thermal insulation material is characterized by being made of aerogel, which has a three-dimensional network structure whose framework is formed by a cluster, an aggregation of primary particles, and containing fine particles which have a three-dimensional network structure whose framework is formed by the primary particles. Such a thermal insulation material has extremely high fluidity and can be moved by the liquid, enabling filling it into and removing it from the space between a pair of panels. The thermal insulation member according to the present invention includes a shape-changing cavity and a thermal insulation material to be accommodated in the cavity. The thermal insulation material is a powder, is flowable, has volume retention performance where the volume is retained before and after the change in cavity shape, and moves within the cavity as the cavity shape is changed.

### TECHNICAL FIELD

The present invention relates to a thermal insulation member and a thermal insulation window. More particularly, the present invention can be suitably used for a thermally insulation member whose thermally insulated location is changeable, and moreover, can be more suitably used for a thermal insulation window whose states can be switched between a transparent state and a light-shielding/heat-shielding state.

### BACKGROUND ART

With the increasing focus on energy saving houses as a countermeasure against global warming, window insulation is extremely important. This is because it is necessary to prevent heat from entering from the outdoors in hot seasons while it is necessary to prevent heat from releasing to the outdoors in cold seasons, and furthermore, it is necessary to consider the balance with lighting.

PTL 1 discloses a window unit capable of controlling the amount of lighting and thermal insulation performance with foamed resin grains filled in or removed from a hollow portion formed between transparent panels, such as double-pane glass windows. The foamed resin grains are transported from a storage tank by air flow to fill the hollow portion to enhance thermal insulation performance, and the foamed resin grains are removed from the hollow portion by air flow and collected in the storage tank to enhance lighting. PTL 1 points out an issue that the foamed resin grains rub against each other and become charged as they are transported by air flow, adhering to the transparent panels constituting the double-pane glass window. This problem is solved by applying an antistatic coating to an inner wall of the double-pane glass window.

PTL 2 discloses a window whose area of a light transmission portion is controllable. A gap is provided between a pair of glass panels, in which gap an elevator is placed. A light-shielded state is created when lightweight particles filled on the upper side of the elevator are lowered to the lower end, and the elevator is raised to increase a transparent area to achieve lighting.

PTL 3 discloses a double-pane glass window configured such that an inner space can be filled with a hydrophobic aerogel granular material and the hydrophobic aerogel granular material can be removed therefrom. The hydrophobic aerogel granular material is made to drop from a storage section to fill the inner space, and is collected in the storage section by a blow-up mechanism. As another embodiment, the following is disclosed: as a thermal insulation material, a hydrophobic aerogel granular material with silica framework as a thermal insulation material is employed, and a transparent conductive film is forms on an inner surface of the double-pane window, letting the inner wall of the double-pane window be electrically charged so that the hydrophobic aerogel can adhere to it.

PTL 4 discloses a light-shielding member in which a space between two transparent panels is filled with aerogel particles. Although there is no mention of a mechanism for switching between a transparent state and light-shielding/heat-shielding state, a detailed analysis of the relationship of visible light transmittance to the particle size of the aerogel particles to be filled is disclosed.

It should be noted that while the technical terms “thermal insulation” and “heat shielding” need to be clearly distinguished in technical context, these are used herein as synonymous.

### CITATION LIST

### Patent Document

PTL 1: Japanese Patent Application Laid-Open No. H05-86780
PTL 2: Japanese Patent Application Laid-Open No. H05-202681
PTL 3: Japanese Patent Application Laid-Open No. H11-30085
PTL 4: Japanese Patent Application Laid-Open No. 2018-178372

### SUMMARY OF THE INVENTION

### Problems to be Solved by the Invention

As shown in PTL 1 to PTL 4, various types of windows that shields heat with a thermal insulation material such as aerogel particles filled in a gap space in double-pane windows have been proposed. In the inventions disclosed in PTL 1 to PTL 3, the balance between thermal insulation and lighting is controlled by a mechanism capable of switching a state filled with aerogel particles or other thermal insulation material and a state in which the thermal insulation material is removed. The control mechanism, however, is complicated. The double-pane windows disclosed in PTL 1 and PTL 3 require an airflow fan and a valve to move the particulate thermal insulation material by airflow, further include a heater for preventing condensation, and a transparent conductive film and a control circuit to electrically charge the inside of the window. The double-pane window disclosed in PTL 2 is equipped with an elevator that mechanically moves the particulate thermal insulation material. This is because aerogel and other thermal insulation materials require a certain size and a certain large physical force is needed to move such thermal insulation materials.

The present inventors have noticed that in general thermal insulation members constituting cold or hot insulation containers (including thermal insulation building materials for walls, floors, roofs, etc.), a mechanism capable of switching between whether or not thermal insulation is to take place, and then capable of controlling thermal insulation performance has not yet been studied well nor put into practical use. This may be because controlling thermal insulation in a thermal insulation member would require as complicated mechanism as that discussed above in the conventional technology regarding windows.

An object of the present invention is to provide a thermal insulation member and a thermal insulation window equipped with a simple mechanism for controlling a thermal insulation state (a location to be insulated and thermal insulation performance).

A means for solving these problems will be described below. Other problems and novel features will become apparent from the description and the accompanying drawings.

### Means for Solving Problems

An embodiment of the present invention is as follows.

A thermal insulation window according to the present invention includes a pair of panels, a space between the panels, a thermal insulation material to fill the space with; and a mechanism capable of filling the space with the thermal insulation material and removing the thermal insulation material from the space. The thermal insulation window has the following characteristics:

the thermal insulation material is made of aerogel, which has a three-dimensional network structure whose framework is formed by a cluster, an aggregation of primary particles, and contains fine particles which have a three-dimensional network structure whose framework is formed by the primary particles.

The mechanism is capable of changing the shape of the space to move the thermal insulation material.

The fine particles constituting the thermal insulation material according to the present invention may additionally have a characteristic that 50% or more of the volume is dispersed with a mode of particle size ranging from 0.1 μm or more to 1.0 μm or less.

The thermal insulation member according to the present invention includes a shape-changing cavity and a thermal insulation material to be accommodated in the cavity. The thermal insulation material is a powder and moves within the cavity as the shape is changed. As used herein, the term “cavity” is referred to as a space in a thermal insulation member that can accommodate a thermal insulation material. For example, a cavity may be a space formed between panels of a pair of panels, or a bag that can accommodate a thermal insulation material. In this specification, a pair of panels or a bag accommodating a thermal insulation material thereinside is referred to as a thermal insulation member, and a space to accommodate the thermal insulation material of the thermal insulation member is referred to as a cavity, while a space for cold/heat retention created by a thermal insulation member is referred to as a container.

### Effect of the Invention

The effect to be produced by the above-described embodiment will be briefly described below.

It is possible to provide a thermal insulation member and a thermal insulation window with a simple mechanism for controlling a thermal insulation state (a location to be insulated and thermal insulation performance).

### BRIEF DESCRIPTION OF THE DRAWINGS

FIG. 1 is a schematic cross-sectional view of an example structure of a thermal insulation window according to an embodiment of the present invention.

FIG. 2 is a schematic cross-sectional view of an example structure of a thermal insulation window according to another embodiment of the present invention.

FIG. 3 is an explanatory view of a structure of general aerogel particles and a structure of fine particles whose framework is formed by primary particles shown in comparison.

FIG. 4 is an explanatory view illustrating an example of the frequency distribution of particle size for general aerogel granules, milled powder, fine powder, and fine particles whose framework is formed by primary particles.

FIG. 5 is an explanatory view showing a method for measuring a dynamic angle of repose.

FIG. 6 is an explanatory view showing a measurement result of the dynamic angle of repose.

FIG. 7 is an explanatory view showing a method for measuring a volume change ratio.

FIG. 8 shows the measurement result of the volume change ratio.

FIG. 9 shows a measurement result of the volume change ratio over time.

FIG. 10 is a schematic cross-sectional view of an example structure of a thermally insulated container in which the thermal insulation member according to the present invention is used.

FIG. 11 is a schematic cross-sectional view of another example structure of the thermally insulated container in which the thermal insulation member according to the present invention is used.

FIG. 12 is a schematic cross-sectional view of yet another example structure of the thermally insulated container in which the thermal insulation member according to the present invention is used.

FIG. 13 is a schematic cross-sectional view of an example structure of the thermal insulation window according to yet another embodiment of the present invention.

### DETAILED DESCRIPTION OF THE INVENTION

### 1. Principle of Solution of the Present Invention

The following is an explanation of the principle by which the present invention could solve the above-described problems.

The present inventors invented a thermal insulation material made of aerogel, which has a three-dimensional network structure whose framework is formed by a cluster, an aggregation of primary particles, and contains fine particles which have a three-dimensional network structure whose framework is formed by the primary particles, for which patent application was filed as Japanese Patent Application No. 2020-193892. This thermal insulation material is herein referred to as TIISA (trademark registration pending from Thermalytica Inc.). TIISA has thermal conductivity equivalent to that of high-performance aerogel and a bulk density of 0.01 g/cm³ or less, which is about one-tenth or smaller than that of general aerogel. This means that TIISA is a lightweight, high-performance thermal insulation material. While the framework of general aerogel is formed by secondary particles, the framework of TIISA is formed mainly by the primary particles that make up the secondary particles, so TIISA is made up of extremely fine particles, and is characterized in that 50% or more of the volume is dispersed with a mode of particle size ranging from 0.1 μm or more to 1.0 μm or less.

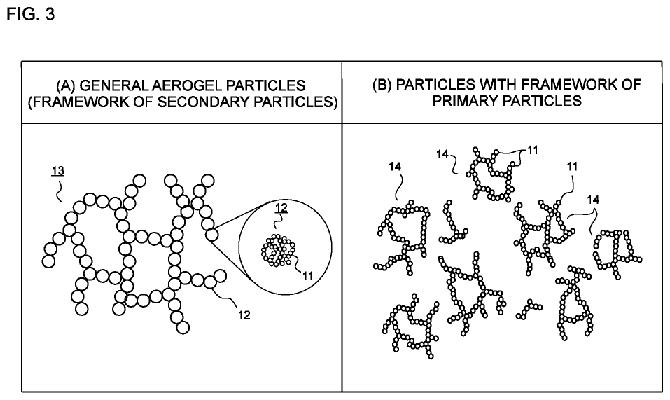

FIG. 3 is an explanatory view of a structure of general aerogel particles and a structure of fine particles whose framework is formed by primary particles shown in comparison. The three-dimensional network structure of general aerogel particles 13 is based on secondary particles 12, which is a cluster of primary particles 11 as a unit (FIG. 3(a)), whereas fine particles (e.g., fine particles of TIISA) 14 of the present invention have a three-dimensional network structure whose framework is formed by primary particles 11 (FIG. 3(b)).

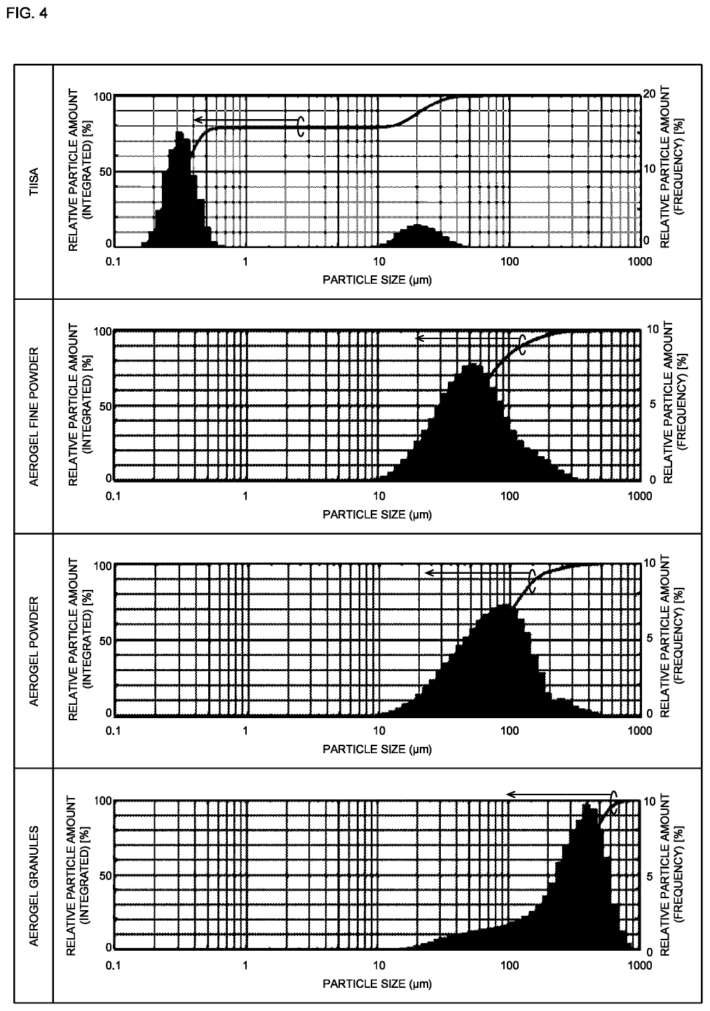

Commonly available aerogels are granules and have a three-dimensional network structure whose framework is formed by secondary particles 12 as a unit. Therefore, if such aerogels are finely pulverized using a pulverizer, the structure of the framework remains unchanged. The following are experimental results. FIG. 4 is an explanatory view illustrating, from the bottom to the top, an example of the frequency distribution of particle size for aerogel granules, aerogel powder, aerogel fine powder, and TIISA, which is fine particles whose framework is formed by primary particles. The aerogel granules are the commonly available aerogel granules. The aerogel powder is produced by grinding aerogel granules at 5,000 to 7,000 rpm for 2 minutes using Spinmix SX08 homogenizer from Mitsui Electric Co., Ltd. The aerogel fine powder is produced by grinding aerogel granules at 21,000 rpm for 20 seconds using STEALTH 885 from Blendtec. In FIG. 4, the particle size is plotted along the horizontal axis and the frequency distribution of the particle size is plotted along the vertical axis. The frequency is shown along the vertical axis on the right and the integrated value along the vertical axis on the left. FIG. 4 shows observational results using a laser diffraction particle size distribution (PSD) measurement device. In this specification, the particle size will be described as measured in PSD measurement. In the PSD measurement, however, not only the diameter of the particles themselves but also aggregation of particles are observed as the particle size, so it is more likely that the true particle size is smaller than the measured value. If there is a difference in particle size depending on the measurement method, conversion should be applied. More specifically, FIG. 4 shows the particle size distribution using Laser Diffraction Particle Size Analyzer SALD-2300 from Shimadzu Corporation. Particle size distribution is an indicator of what size (particle size) of particles are contained at what proportion (relative particle quantity with the total as 100%) in a group of sample particles to be measured, and the dimension (order) of the particle quantity is volume-based.

Generally distributed aerogel granules have only one peak of relative particle volume with an average particle size of about 400 μm (FIG. 4, bottom row). When the aerogel granules are milled using the device as described above, the aerogel powder and the aerogel fine powder have an average particle size of about 90 μm and 50 μm, respectively, with a single peak in relative particle volume (3rd and 2nd row). In contrast, TIISA has a first peak with an average particle size of about 20 μm and a second peak with an average particle size of about 0.3 μm, and the relative particle volume is 21.2% for the first peak with an average particle size of about 20 μm and 78.8% for the second peak with an average particle size of 0.3 μm. This is because the first peak with an average particle diameter of about 20 μm is formed by fine particles with a three-dimensional network structure whose framework is formed by secondary particles 12 as a unit, while the second peak with an average particle diameter of about 0.3 μm is formed by fine particles with a three-dimensional network structure whose framework is formed by primary particles.

Since the framework of the three-dimensional network structure of general aerogel is formed by secondary particles, it is difficult to produce particles with a diameter of 10 μm or less, no matter how high the milling conditions are. To produce fine particles which have a three-dimensional network structure whose framework is formed by the primary particles, unlike the usual aerogel production process, a fundamental change in the production method is required as described in Japanese Patent Application No. 2020-193892, such as drastically changing the aging conditions as well as the milling conditions.

The present inventors have newly discovered through experiments described below that this TIISA exhibits high flowability and volume retention performance comparable to that of liquids. Dynamic angle of repose and volume change ratio were employed as indicators of flowability and volume retention performance, respectively. For example, the angle of repose employed in PTL 4 is a static angle of repose, which is suitable for measuring powders, but not necessarily suitable for describing flowability of fluids. The present inventors have also noticed another important characteristics that although the thermal insulation material receives external force as it flows, or moves, the volume of the material stays unchanged, i.e., the volume retention performance.

### Dynamic Angle of Repose

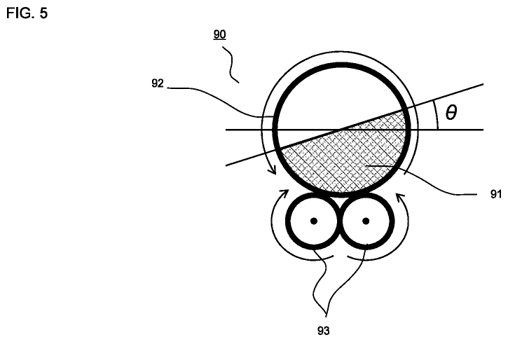

FIG. 5 is an explanatory view (schematic cross-sectional view) showing a method for measuring a dynamic angle of repose. Dynamic angle of repose measurement device 90 is configured as follows: sample 91 is placed in cylindrical glass container 92, which is placed and is made to rotate on two pipe-shaped rollers 93. Sample 91 is observable from the bottom side of the glass container 92. The surface of sample 91 is kept horizontal when it is not rotating, and the surface tilts as the rotation speed increases. The angle θ from the flat surface is measured as the dynamic angle of repose.

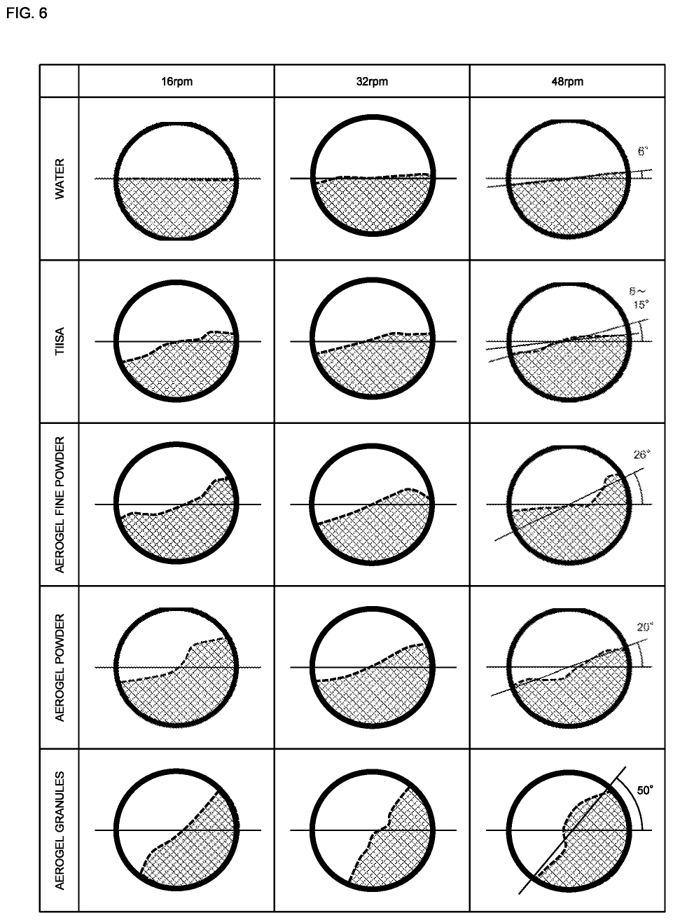

FIG. 6 is an explanatory view showing a measurement result of the dynamic angle of repose. Experimental results for rotational speeds of 16 rpm, 32 rpm, and 48 rpm are shown with the top row showing water, the other tows are in the same order as in FIG. 4, starting from the bottom, aerogel granules, aerogel powder, aerogel fine powder, and TIISA, which are fine particles whose framework is formed from primary particles. Although the surface profile is not flat as shown by the dashed line in FIG. 6, if the angle θ is quantified through linear approximation, θ is 6° F. or water and 50°, 20°, and 26° F. or aerogel granules, aerogel powder, and aerogel fine powder, respectively, while TIISA is 6 to 15° at a rotation speed of 48 rpm. The dynamic angle of repose is largest in aerogel granules, and smaller in TIISA than in aerogel powder and aerogel fine powder, indicating that TIISA is similar to water.

### Volume Change Ratio

The volume change ratio is one of the indicators of flowability of TIISA that the present inventors employ in the present invention, and is measured by the following method.

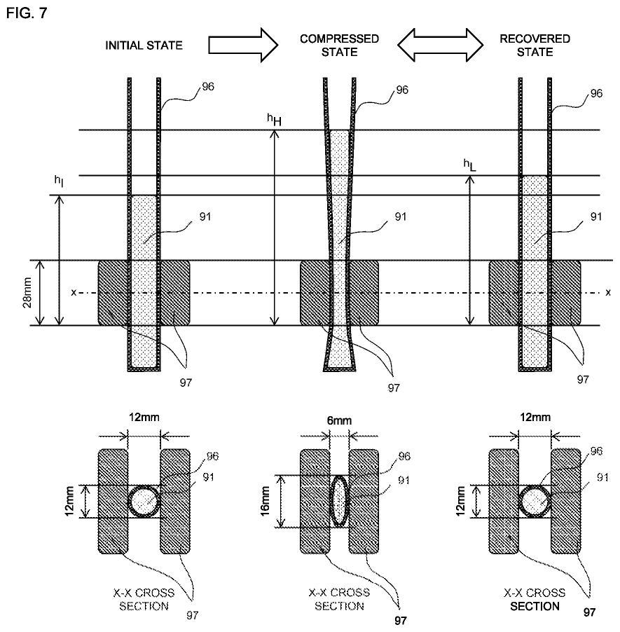

FIG. 7 is an explanatory view showing a method for measuring a volume change ratio. Sample 91 is placed in a transparent, cylindrical elastic tube 96 and sandwiched between pressure blocks 97 from both sides. In FIG. 7, the upper half show the side cross-sectional views, and the lower half show the cross-sectional views taken along x-x. From the initial state, compression block 97 is narrowed and compressed to become a compressed state, and then returned to its original state (herein referred to as a recovery state). Elastic tube 96 is a pipe-shaped container with a diameter of 12 mm and a wall thickness of 0.25 mm. In the compressed state of elastic tube 96, the short side in the compressed direction is 6 mm and the long side in the vertical direction is 16 mm, but in the recovered state, it returns to its original diameter of 12 mm. Based on the height h_{I} of sample 91 in the initial state, the height becomes h_{H} in the compression state and h_{L} in the recovery state. If it is completely fluid and there is no change in volume, the height h_{L} in the recovered state will recover to the initial height h_{I}.

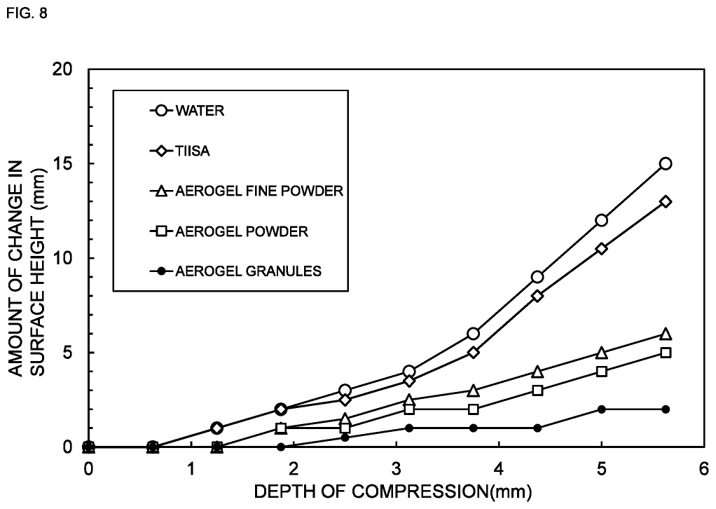

FIG. 8 shows the measurement results of the volume change ratio. The graph shows the depth of compression by compression block 97 plotted on the horizontal axis and the change in surface height from the initial state, h_{H} to h_{I}, plotted on the vertical axis. The amount of change in surface height from the initial state is not strictly but roughly proportional to the depth of compression. The maximum change in surface height for water, a perfect fluid, was 15 mm, compared to 13 mm for TIISA, 6 mm for aerogel fine powder, 5 mm for aerogel powder, and 2 mm for aerogel granules. When the amount of change in water was set to 1, the relative values of change in TIISA, aerogel fine powder, aerogel powder, and aerogel granules were 0.87, 0.40, 0.33, and 0.13, respectively.

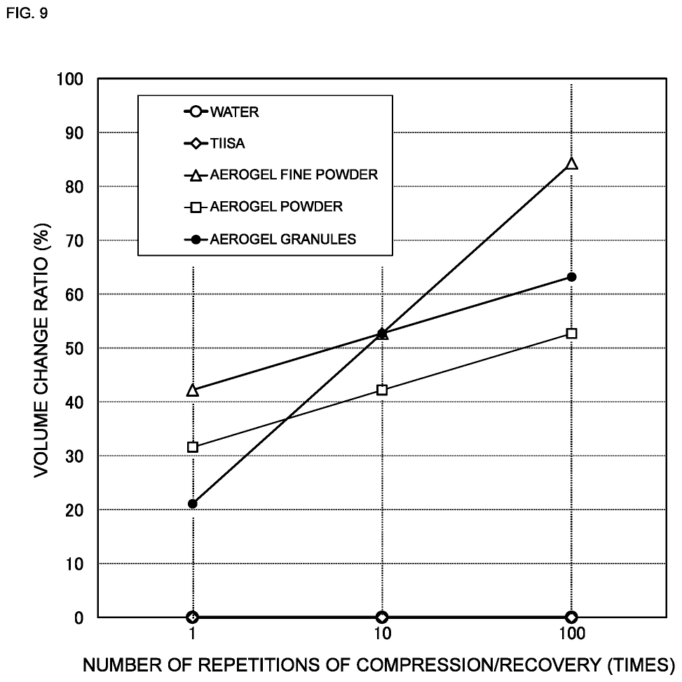

FIG. 9 shows a measurement result of the volume change ratio over time. The number of times the compression and recovery states were repeated was plotted on the logarithmic horizontal axis, and the volume change ratio of sample 91 from the initial state plotted on the vertical axis. Just as the volume of water, a perfect fluid, did not change after repeated compression and recovery (volume change ratio=0%), the volume change ratio of TIISA did not change after 100 cycles of compression and recovery (volume change ratio=0%). On the other hand, the volume change ratio of aerogel granules was 21%, 53%, and 63% for 1, 10, and 100 cycles of compression and recovery, respectively, the volume change ratio of aerogel powder was 32%, 42%, and 53% for 1, 10, and 100 cycles of compression and recovery, respectively, and the volume change ratio of aerogel fine powder was 42%, 53%, and 84% for 1, 10, and 100 cycles of compression and recovery, respectively. All of the changes are in the direction of the volume being larger than the initial state. This is thought to be the result of repeated compression and recovery, which partially destroys the three-dimensional network structure, resulting in larger gaps. The experimental results and discussion indicate generally available aerogels, whether in granule form or crushed, induce irreversible changes in volume with compression and recovery.

It is also found that TIISA can be made extremely hydrophobic. (TIISA can also be processed to be hydrophilic.) The present inventors noticed that this high fluidity of TIISA is comparable to that of a liquid, and realized that it is possible to move TIISA by liquid instead of by air as in PTL 1 to PTL 3. The present inventors also found that the liquid can be water as TIISA is highly hydrophobic.

Using a liquid, especially water, as a medium allows relatively easy sealing to prevent diffusion or leakage of the liquid, and easy movement of the liquid. If the medium is a water-based liquid, the liquid can form a clear interface without mixing with TIISA, which is highly hydrophobic. Furthermore, the mechanism for accommodating and moving the liquid (water) as the medium requires only a simple elastic cavity, making it an extremely simple mechanism. This is because TIISA can be moved to a desired position when such an elastic cavity is compressed when, for example, pressure is applied to it and pushes the medium out and, conversely, can return to its original position when the elastic cavity is released from compressed state.

Although the term “TIISA” is used herein to describe fine particles that can be used as thermal insulation material and “TIISA” is also used to refer to some material substances for thermal insulation material in this specification, it should be understood that the same solution principles apply to any material with equivalent flow and volume retention performance.

An application of this principle can provide a simple configuration of a mechanism for moving a thermal insulation material to a desired position. More particularly, application to a double-pane window can provide a simple configuration of a mechanism for switching between thermal insulation and lighting.

### 2. Summary of Embodiment

First, a summary of typical embodiments disclosed in the present application will be described. Reference numerals in the drawings referred to in parentheses in the summary description of the typical embodiments are merely illustrative of what are included in the concepts of the components to which they are attached.

[1]<Thermal Insulation Window in which TIISA is Used as Thermal Insulation Material>

A typical embodiment of the present invention is thermal insulation window (10) including a pair of panels (7), a space (8) between the panels, a thermal insulation material (1) to fill the space, and a mechanism (2 to 6) capable of moving the thermal insulation material into the space to fill it and removing the thermal insulation material from the space. Thermal insulation window (10) has the following features:

the thermal insulation material is made of aerogel (13), which has a three-dimensional network structure whose framework is formed by cluster (12), an aggregation of primary particles (11), and contains fine particles (14) which have a three-dimensional network structure whose framework is formed by primary particles (11).

This can provide a thermal insulation window with a simple mechanism for controlling thermal insulation and lighting. Here, the mechanism for moving the thermal insulation material can be realized in various ways. Since the thermal insulation material has high fluidity and volume retention performance comparable to that of a liquid, the mechanism may move the thermal insulation material by using the liquid as a medium as described in [3] below, or may move the thermal insulation material by applying force to the thermal insulation material itself by controlling the volume of the space (cavity) that accommodates the thermal insulation material, just as a liquid does.

It should be noted that “a pair of panels” means “at least one pair of panels,” and therefore a thermal insulation window may be a multiple-pane window with multiple panels (7) and multiple spaces (8). The filling or the removal of the thermal insulation material into and from multiple spaces may be conducted uniformly; or the filling or the removal may be conducted independently; or some of the spaces may be left unfilled or the thermal insulation material in some spaces may be left unremoved.

[2]<TIISA Characteristics: particle size>

In the thermal insulation window of [1], 50% or more of the volume of the fine particles constituting the thermal insulation material is dispersed with a mode of particle size ranging from 0.1 μm or more to 1.0 μm or less.

This feature ensures that the thermal insulation material has a high degree of fluidity.

### [3]<Mechanism for Moving Thermal Insulation Material Using Liquid as Medium>

In the thermal insulation window of [1] or [2], the mechanism is capable of moving the liquid in contact with the thermal insulation material to move the thermal insulation material.

This can provide a thermal insulation window with a simple mechanism for controlling thermal insulation and lighting. Since a mechanism using a liquid as a medium to move the thermal insulation material is employed, a widely used mechanism for moving a liquid while reducing leakage of the liquid can be employed.

[4]<Medium that Moves Thermal Insulation Material is Water>

In the thermal insulation window of [3], the liquid is water-based.

This allows for a low-cost configuration of the mechanism for moving the thermal insulation material.

### [5]<Switching Between Thermal Insulation Material Filling/Air>

In the thermal insulation window of any one of [1] to [4], the mechanism includes elastic cavity (4) capable of accommodating the thermal insulation material (and the liquid) below the space, and compression mechanism (3) capable of increasing and reducing the volume of the elastic cavity.

The mechanism moves the thermal insulation material from the elastic cavity into the space by reducing the volume of the elastic cavity with the compression mechanism, and moves the thermal insulation material from the space into the elastic cavity by increasing the volume of the elastic cavity with the compression mechanism.

This allows for a simple configuration of the mechanism for moving the thermal insulation material.

### [6]<Switching Between Thermal Insulation Material Filling/Liquid (Water)>

In the thermal insulation window of [3] or [4], the mechanism includes upper elastic cavity (5) capable of accommodating the thermal insulation material above the space, lower elastic cavity (4) capable of accommodating the liquid below the space, and compression mechanism (3) capable of increasing and reducing the volume of the lower elastic cavity.

The mechanism moves the liquid from the elastic cavity into the space by reducing the volume of the lower elastic cavity with the compression mechanism and moves the thermal insulation material from the space to the upper elastic cavity, and moves the liquid from the space into the lower elastic cavity by increasing the volume of the lower elastic cavity with the compression mechanism and moves the thermal insulation material from the upper elastic cavity to the space.

This allows for a simple configuration of the mechanism for moving the thermal insulation material.

### [7]<Thermal Insulation Member Formed Using Flowable Thermal Insulation Material>

A typical embodiment of the present invention is thermal insulation member (20) including shape-changing cavity (21) and thermal insulation material (1) to be accommodated in the cavity. The thermal insulation material is a powder and moves within the cavity as the shape is changed.

This can provide a thermal insulation member with a simple mechanism for controlling insulation performance. A thermal insulation member may be a member that constitute a thermally insulated containers, etc., and may be a thermal insulation building material, like thermal insulation window described above, as well as a member constituting a thermally insulated container. A cavity may have a gap between sidewalls of a pair of panels, etc., for example, to accommodate a thermal insulation material therein, and the shape of the cavity is arbitrarily decided. The change in shape may include, for example, any change that affects the volume of the cavity, as well as any change in shape that affects the location where the thermal insulation material is held, any change in shape that affects the thickness of the thermal insulation material, etc.

### [8]<Thermal Insulation Member Using TIISA as Thermal Insulation Material>

In the thermal insulation member of [7], the thermal insulation material is made of aerogel (13), which has a three-dimensional network structure whose framework is formed by a cluster (12), an aggregation of primary particles (11), and contains fine particles (14) which have a three-dimensional network structure whose framework is formed by the primary particles.

This feature ensures that the thermal insulation material has a high degree of fluidity and volume retention performance.

[9]<Thermal Insulation Member Using Thermal Insulation Materials with Flowability and Volume Retention Performance>

In the thermal insulation member of [7], the thermal insulation material is flowable, and has volume retention performance where the volume is retained before and after the change in cavity shape.

Any thermal insulation material having high flowability and volume retention performance can be used for the thermal insulation member of the present invention, even if the material lacks the characteristics of [7] described above. This is valid for all embodiments, including the thermal insulation windows in [1] through [5] described above.

### <Reduction Pressure in Cavity>

In the thermal insulation member of [7] or [8], the inner pressure of the cavity is set lower than the external atmospheric pressure.

This can significantly reduce the thermal conductivity (i.e., improve thermal insulation performance) of the thermal insulation member. Especially in [7], the improvement in thermal insulation performance is more pronounced.

<Cavity Filling with Gas with Lower Thermal Conductivity than Air>

In the thermal insulation member of [7] or [8], the cavity is filled with a gas of lower thermal conductivity than air (e.g., carbon dioxide).

This can reduce thermal conductivity (i.e., improve thermal insulation performance) of the thermal insulation member. After reducing the pressure as described in above [9], the filling state can be maintained longer and easier than maintaining the lower pressure state. Combination with the following to may also be achieved easily.

### <Movement of Thermal Insulation Material Using Liquid as Medium>

In the thermal insulation member of [7], the cavity further accommodates a liquid (2) that is exclusive against the thermal insulation material. As used herein, the term “exclusivity” is an antonym of “affinity”, meaning the property of being immiscible, corresponding to hydrophobicity of a property of a substance that does not mix with water, for example.

This allows for a simple configuration of the mechanism for moving the thermal insulation material.

### <Movement of Thermal Insulation Material Using Water as Medium>

In the thermal insulation member of [7], the thermal insulation material is hydrophobic and the cavity further accommodates water (2).

Thus, water can be employed as a medium for moving the thermal insulation material and a simple mechanism therefor is provided.

### <Thermal Insulation Material Moving Mechanism>

In the thermal insulation member of [7], the cavity includes one or more pairs of panels (21i, 21w) and thermal insulation material storage (23). Each of the one or more pairs of panels has gap (22) inside capable of accommodating the thermal insulation material. the thermal insulation material storage accommodates the thermal insulation material, and pushes the thermal insulation material into the gap between the panels or collects the thermal insulation material from the gap between the panels as a volume of a space that continues with the gap is changed.

This allows the thermal insulation material to move between the gap in the paired panels and the thermal insulation material storage, thereby controlling the thermal insulation performance of the panel portion.

### <Thermal Insulation Material Moving Mechanism Using Liquid as Medium>

In the thermal insulation member of [12], the cavity includes one or more pairs of panels (21i, 21w), thermal insulation material storage (23), and liquid storage (24). Each of the one or more pairs of panels has gap (22) inside capable of accommodating the thermal insulation material.

The thermal insulation material storage has a space continued with the gap and is capable of accommodating the thermal insulation material in the space. The liquid storage can accommodate the liquid, and push the thermal insulation material into the gap between the panels or collect the thermal insulation material from the gap between the panels as a volume of the space that continues with the gap is changed to move the liquid.

This allows the thermal insulation material to move between the gap in the paired panels and the thermal insulation material storage, thereby controlling the thermal insulation performance of the panel portion. Liquid storage (24) is a volume control mechanism using a liquid as a medium. Employing a liquid (e.g., water) as a medium for moving the thermal insulation material provides an effect that, for example, leakage can be prevented even if any moving parts exist, resulting in an increase in the degree of freedom in designing the volume control mechanism.

### 3. Details of the Embodiments

Details of the embodiments will be described in more detail.

### First Embodiment

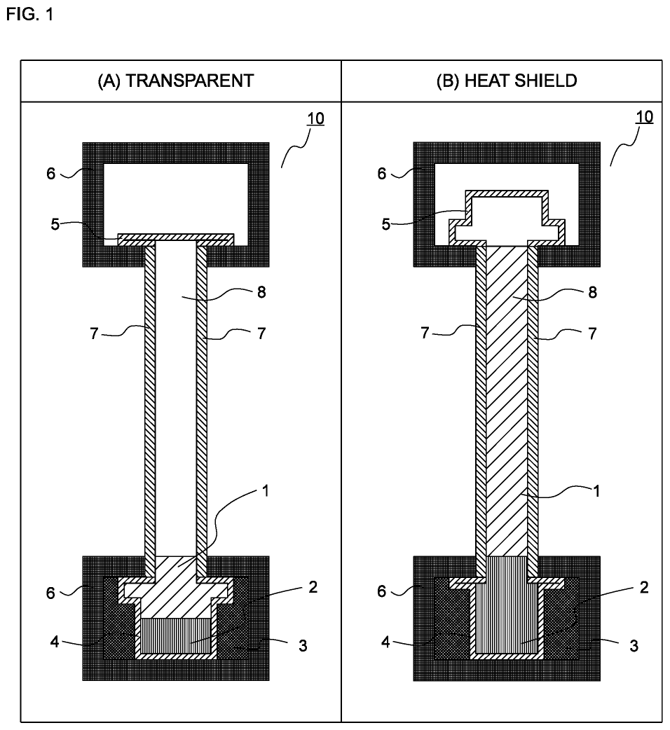

FIG. 1 is a schematic cross-sectional view of an example structure of thermal insulation window (10) according to an embodiment of the present invention.

Thermal insulation window 10 according to the present embodiment includes a pair of panels 7, space 8 between the panels 7, thermal insulation material 1 to fill space 8 with, mechanism 2 to 6 capable of moving thermal insulation material 1 to fill space 8 with and removing thermal insulation material 1 from space 8. Thermal insulation material 1 is made of aerogel 13, which has a three-dimensional network structure whose framework is formed by cluster 12, an aggregation of primary particles 11, and contains fine particles 14 which have a three-dimensional network structure whose framework is formed by the primary particles 11. The mechanism described above is a mechanism capable of moving liquid 2 in contact with thermal insulation material 1 to move thermal insulation material 1. Employing liquid 2 as a medium for moving thermal insulation material 1 provides an advantage that since sealing is easier than when gas (air) is used, and there is almost no change in volume when pressure is applied, the applied pressure can be transmitted directly to thermal insulation material 1 to move. This can provide thermal insulation window 10 with a simple mechanism for controlling thermal insulation and lighting.

In fine particles 14 constituting thermal insulation material 1, it is suitable that the frequency distribution of the particle size has a mode (peak) of dispersion at 1.0 μm or below. Moreover, it is more suitable that 50% or more of the volume is dispersed with a mode of particle size ranging from 0.1 μm or more to 1.0 μm or less. Since thermal insulation material 1 has this feature, high fluidity of thermal insulation material 1 is ensured.

Thermal insulation material 1 is suitably, but not limited to, a powder made of fine particles having these characteristics with respect to particle size distribution, and may be a material having the same level of flowability (dynamic angle of repose) and volume retention performance as described above. For example, with respect to the dynamic angle of repose, the experimental results shown in FIG. 6 indicate that thermal insulation material with a dynamic angle of repose up to three to four times that of water can be employed. It is also desirable that the volume retention performance is comparable to that of liquids. The mechanism to move the thermal insulation material is optimally designed using, as parameters, force applied to the thermal insulation material to move it, frequency with which it is moved, and lifetime of the thermal insulation material.

In thermal insulation window 10, it is suitable if liquid 2 is a water-based liquid. This is because by making thermal insulation material 1 hydrophobic and highly fluid as described above, thermal insulation material 1 does not mix with water-based liquid 2, and a clear interface is formed therebetween allows liquid 2 to move smoothly. In addition, employing water as liquid 2 allows for a low-cost configuration of the mechanism for moving the thermal insulation material.

The mechanism for moving thermal insulation material 1 can be configured, for example, as shown in FIG. 1. In thermal insulation window 10, the mechanism includes lower elastic cavity 4 and upper elastic cavity 5 on the lower and upper sides, respectively, of space 8 located between transparent panels 7 made, for example, of glass, supports panels 7, as well as accommodates the lower and upper elastic cavities 4 and 5 at the top and bottom, respectively. Lower frame 6 accommodates compression mechanism 3 that can control the volume of lower elastic cavity 4. As shown in FIG. 1(A), lower elastic cavity 4 has an enough volume to accommodate thermal insulation material 1 and liquid 2 in lower frame 6. At this time, space 8 is filled with air, so that thermal insulation window 10 is transparent and is transmitting visible light. Upper elastic cavity 5 has the smallest volume. Lower elastic cavity 4 is pressurized by compression mechanism 3 provided around it, which reduces the volume of lower elastic cavity 4 and pushes thermal insulation material 1 into space 8. Space 8 is filled with thermal insulation material 1 and shields heat. At this time, upper elastic cavity 5 expands to accommodate the air pushed out of space 8. This allows for a simple configuration of the mechanism for moving the thermal insulation material.

Lower elastic cavity 4 and upper elastic cavity 5 are bonded to panel 7 at the lower and upper ends, respectively, and sealed to prevent thermal insulation material 1 from leaking out of space 8 and to prevent liquid 2 from volatilizing. Lower and upper elastic cavities 4, 5 may be made of, for example, rubber or latex. It is suitable that lower elastic cavity 4 is configured to expand and maximize its volume under the weight of the accommodated liquid 2. It is suitable to configure such that upper elastic cavity 5 expands naturally when air is accommodated therein and lower elastic cavity 4 contracts naturally when space 8 is depressurized as liquid 2 returns to lower elastic cavity 4. Compression mechanism 3 that compresses lower elastic cavity 4 may be made, for example, by a mechanism that transmits the pressure applied from outside the frame as it is or via amplification of displacement by means of a gear.

The mechanism for moving thermal insulation material 1 may be implemented in various ways different from that of the first embodiment. For example, a cavity to accommodate thermal insulation material 1 may be provided below space 8 between the pair of panels 7 instead of lower elastic cavity 4, and liquid 2, a medium, may be injected into that cavity to move thermal insulation material 1 into space 8. This is effective in that it can be configured in a case where panel 7 is large, the volume of thermal insulation material 1 to fill space 8 is large, and the power required to move thermal insulation material 1 into space 8 is large, liquid 2 can be injected using energy such as electricity.

For example, lower elastic cavity 4 may be configured to be widened to the left and right window frames. The window frame can be made smaller by effectively utilizing the volume of the window frame that accommodates liquid (water) 2. Also by balancing the water level appropriately when liquid (water) 2 is accommodated in the left and right window frames, the weight of liquid (water) 2 accommodated in the window frame on either side can be used as the force to push thermal insulation material 1 up from within the lower frame, so thermal insulation material 1 can be moved with weaker force.

Although the gas to fill space 8 has been described as air, the gas may be replaced by a gas of lower thermal conductivity, e.g., carbon dioxide. This reduces the degradation of heat shield performance in the transparent state.

### Second Embodiment

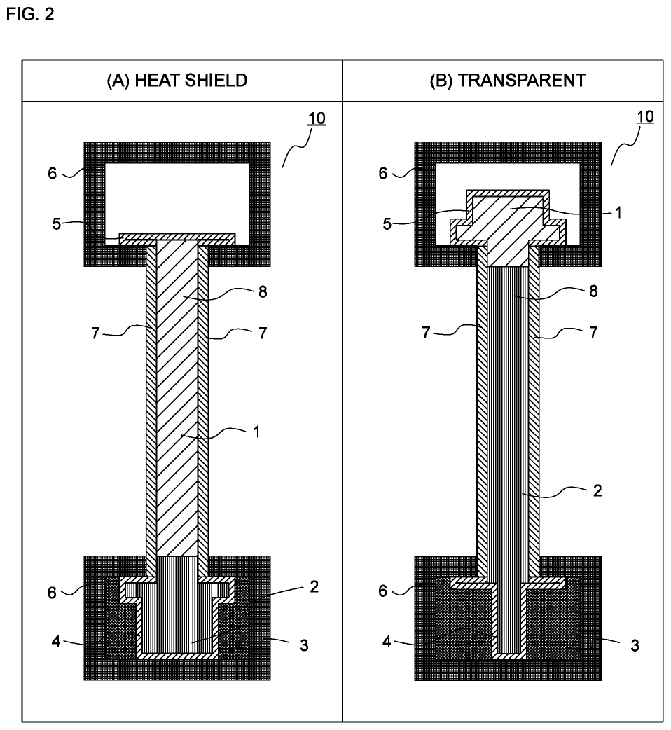

FIG. 2 is a schematic cross-sectional view of an example structure of a thermal insulation window 10 according to another embodiment of the present invention. Although the structure of thermal insulation window 10 in the second embodiment is basically similar to thermal insulation window 10 of the first embodiment shown in FIG. 1, lower elastic cavity 4 has a volume capable of accommodating liquid 1 in lower frame 6, and upper elastic cavity 5 has a volume capable of accommodating thermal insulation material in upper frame 6. Thermal insulation window 10 becomes a heat-shielding state (FIG. 2(A)) when lower elastic cavity 4 accommodates liquid 2 and space 8 is filled with thermal insulation material 1, and becomes a transparent state (FIG. 2(B)) when lower elastic cavity 4 is compressed to push liquid 2 into space 8 and upper elastic cavity 5 accommodates thermal insulation material 1. This explanation assumes, of course, that liquid 2 is transparent. By making liquid 2 as translucent as thermal insulation material 1, the heat shield performance can be controlled without changing the transparency and thus without affecting the lighting. Liquid 2 may also be more opaque than thermal insulation material 1. This type of embodiment allows for a simple configuration of the mechanism for moving the thermal insulation material.

By using water as liquid 2, the mechanism can be configured at a lower cost. If panel 7 is made of a hydrophilic material such as glass, the inner walls of panel 7 will become wet when the liquid (water) 2 is discharged, but since space 8 is filled with the translucent thermal insulation material 1 and the window is also translucent, so aesthetic appearance will not be impaired.

The detailed implementation and variations described in the first embodiment can be applied to the second embodiment.

### Third Embodiment

Although both the first and second embodiments are mechanisms (4-6) that use liquid (water) 2 as a medium to move thermal insulation material 1, mechanisms to move thermal insulation material 1 can be realized in various other ways.

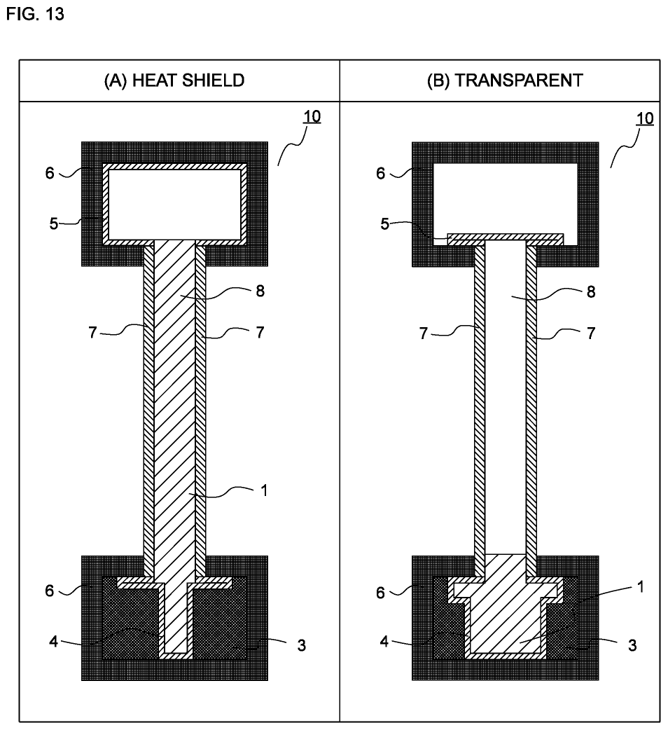

FIG. 13 is a schematic cross-sectional view of an example structure of the thermal insulation window 10 according to yet another embodiment of the present invention. Although the structure of thermal insulation window 10 in the third embodiment is basically similar to thermal insulation window 10 of the first and second embodiments shown in FIGS. 1 and 2, the mechanism is to apply force to thermal insulation material 1 itself to move it without using liquid (water) 2 as a medium. That is, lower elastic cavity 4 has a volume to accommodate thermal insulation material 1 in lower frame 6, and upper elastic cavity 5 has a volume to accommodate the air pushed out by thermal insulation material 1 into upper frame 6. Other configurations are the same as those in the first and second embodiments, so redundant explanations will be omitted.

Thermal insulation window 10 becomes in a heat-shielding state (FIG. 13(A)) when lower elastic cavity 4 is compressed and the accommodated thermal insulation material 1 is pushed out and to fill space 8. At this time, the gas, such as air, in space 8 is further pushed out, causing upper elastic cavity 5 to expand within frame 6. On the other hand, when lower elastic cavity 4 is released from compression and expands, leaving thermal insulation material 1 pushed out into space 8 is accommodated back into lower elastic cavity 4, thermal insulation window 10 becomes transparent (FIG. 13(B)). Therefore, a mechanism can be configured to move thermal insulation material 1 by applying a direct force to it. The detailed implementation and variations described in the first embodiment can be applied to the third embodiment. Although the present third embodiment is an example in which cavities 4 and 5 are made of elastic material, cavities 4 and 5 do not necessarily need to be made of elastic material as long as their volume can be controlled.

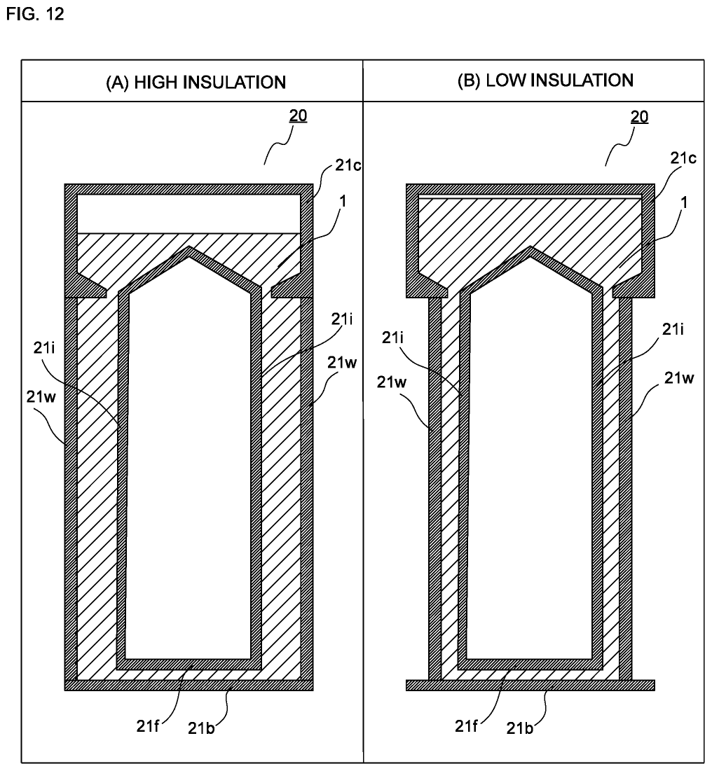

In addition, the third embodiment can be positioned as an embodiment in which the fourth embodiment described below is applied to thermal insulation window 10. That is, a thermal insulation window which includes a shape-changing cavity, and a thermal insulation material to be accommodated in the cavity, in which the thermal insulation material may be a powder and a material that moves within the cavity as the cavity changes its shape. The thermal insulation material, a powder, is required to have the high fluidity, and it is more suitable if it has the same level of volume retention performance as a liquid. In this case, variation described in the fourth embodiment may be applied to thermal insulation window 10 of the third embodiment. For example, although not illustrated, a thermal insulation window whose thermal insulation performance can be controlled by controlling the spacing (gap) between a pair of panels 7, resembling the example structure shown in FIG. 12, may be configured.

### Fourth Embodiment

Although the first, second and third embodiments are examples in which the present invention is applied to thermal insulation window 10, the present invention can be applied to more general thermal insulation members. More particularly, a more general embodiment of the present invention is a thermal insulation member including a shape-changing cavity and a thermal insulation material to be accommodated in the cavity. The thermal-insulating material may be a powder and a material that moves within the cavity as the cavity changes its shape. The thermal insulation material, a powder, is required to have the same level of fluidity as a liquid, and it is more suitable if it has the same level of volume retention performance as a liquid. This can provide a thermal insulation member with a simple mechanism for controlling insulation performance.

A suitable material as a thermal insulation material is TIISA. TIISA is a powder made of aerogel 13, which has a three-dimensional network structure whose framework is formed by cluster 12, an aggregation of primary particles 11, and contains fine particles 14 which have a three-dimensional network structure whose framework is formed by primary particles 11. With this structure, TIISA achieves the above-described flowability and volume retention performance required of thermal insulation materials.

It is suitable that the cavity has lower pressure than the external atmospheric pressure. This can significantly reduce the thermal conductivity (i.e., improve thermal insulation performance) of the thermal insulation member. Especially when TIISA is employed as the thermal insulation material, the improvement in thermal insulation performance is more pronounced. In TIISA, of which the framework accounts for 1% or less of the total volume, convection is suppressed by exhausting air from the spaces (gaps) that make up the remaining 99% or more of the volume, to thereby reduce pressure. Since the contribution of space (gaps) to thermal conductivity is large, the improvement in thermal insulation performance due to exhaust air is significant. In conventional aerogel, in contrast, the ratio of framework (solid) in the total volume is as high as 5%, and contribution of the framework (solid) to thermal conductivity is large, so even if gaps are evacuated to reduce convection, the improvement in thermal insulation performance is relatively small.

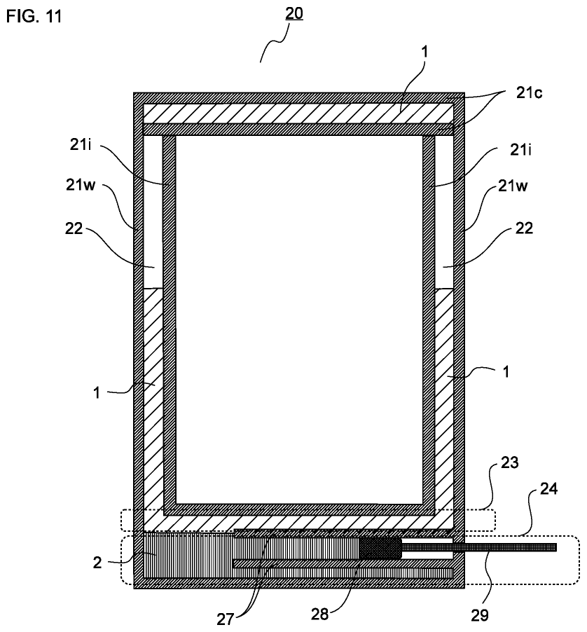

Alternatively, the cavity may be filled with a gas of lower thermal conductivity than air (e.g., carbon dioxide). This can reduce thermal conductivity (i.e., improve thermal insulation performance) of the thermal insulation member. After reducing the pressure as described above, the filling state can be maintained longer and easier than maintaining the low pressure state. When a liquid (e.g., water) is employed as the medium for moving the thermal insulation material as in the example shown in FIG. 11, it is suitable to use a gas of lower thermal conductivity (e.g., carbon dioxide) than the that of the low pressure described above.

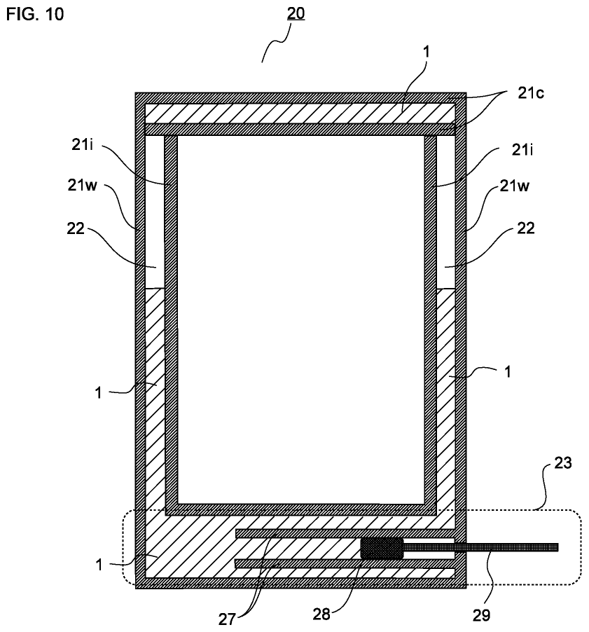

FIG. 10 is a schematic cross-sectional view of an example structure of thermally insulated container 20 in which the thermal insulation member according to the present embodiment is used. Thermally insulated container 20 is made of a surrounding thermal insulation member. That is, container 20 includes sidewalls formed by a cavity with gap 22 located between inner wall 21i and outer wall 21w, and cavity 21c at a canopy portion, and a cavity provided at a bottom portion and forming thermal insulation material storage 23. Cavity 21c at the canopy portion is filled with thermal insulation material 1. A continuous space is formed between gap 22 located between inner wall 21i and outer wall 21w and thermal insulation material storage 23, and the space is filled with thermal insulation material 1. Thermal insulation material storage 23 is configured to change its volume: by reducing the volume, thermal insulation material 1 inside it is fed to the gap 22 between inner wall 21i and outer wall 21w, and by restoring the volume, thermal insulation material 1 is collected from the gap 22 into thermal insulation material storage 23.

The mechanism for changing the volume of thermal material storage 23 may include, for example, outer cylinder 27, piston 28, and operating rod 29 that pushes piston 28 in or pulls piston 28 out. To prevent thermal insulation material 1 inside thermal material storage 23 from also entering a contact area between outer cylinder 27 and piston 28, a bag made of flexible sheet such as latex (not shown) may be closely attached at the tip of outer cylinder 27 to the tip of the piston 28 to also separate the inside and outside spaces.

The portion of the sidewall where the gap 22 is filled with thermal insulation material 1 is high in thermal insulation performance, while the portion at which thermal insulation material 1 has not reached is low in thermal insulation performance. Thermal insulation material 1 can be selectively moved to areas where high thermal insulation performance is required, such as where the temperature difference between inside and outside is high. It can also be said that the thermal insulation performance of the entire sidewall is controlled by the size of the area at which thermal insulation material 1 has reached to fill the gap.

FIG. 11 is a schematic cross-sectional view of another example structure of thermally insulated container 20 in which the thermal insulation member according to the present embodiment is used. Thermally insulated container 20 in this example differs from thermally insulated container 20 in FIG. 10 in that the bottom cavity is formed by thermal insulation material storage 23 and liquid storage 24. Other configurations are common to thermally insulated container 20 shown in FIG. 10, so explanation thereof will be omitted. Although the mechanism for controlling the volume of the bottom cavity may be configured in the same way as the mechanism for changing the volume of thermal material storage 23 shown in FIG. 10, the bottom cavity accommodates liquid 2 in addition to thermal insulation material 1, when the volume is changed by the mechanism, it is liquid 2 that is directly moved and thermal insulation material 1 is pushed and moved by liquid 2. Liquid 2 is exclusive against thermal insulation material 1, i.e., liquid 2 is a material that forms a clear interface against the thermal insulation material without mixing with thermal insulation material 1. When, for example, TIISA is employed as thermal insulation material 1, liquid 2 may suitably be a water-based liquid. The extremely high hydrophobicity of TIISA allows itself to move as the volume changes through a clear interface without mixing with water. By introducing liquid (water) 2 into the bottom cavity, known means may be employed to control water leakage, even in a case where a volume control mechanism such as outer cylinder 27 and piston 28 is provided. That is, employing a liquid (e.g., water) as a medium for moving the thermal insulation material provides an effect that, for example, leakage can be prevented even if any moving parts exist, resulting in an increase in the degree of freedom in designing the volume control mechanism.

FIG. 12 is a schematic cross-sectional view of yet another example structure of the thermally insulated container in which the thermal insulation member according to the present embodiment is used. While the volume control mechanism is provided in the bottom cavity in the example structures shown in FIGS. 10 and 11, thermal insulation performance is controlled by changing the thickness of thermal insulation material 1 filled in the cavity in the sidewall portions. The cavity in the sidewall portions is formed by a gap between inner wall 21i and outer wall 21w. The bottom of container 20 has a double-layered structure of floor surface 21f and bottom surface 21b, with the gap filled with thermal insulation material 1. Cavity 21c of the canopy has a continued gap and space between inner wall 21i and outer wall 21w, which allows thermal insulation material 1 to move freely therebetween. By expanding outer wall 21w outward, the gap between inner wall 21i and outer wall 21w is maximized and thermal insulation performance is also maximized (FIG. 12(A)). By pushing the outer wall 21w toward inner wall 21i to narrow the gap, thermal insulation material 1 filled therein is pushed out into cavity 21c of the canopy, which reduces the thickness of thermal insulation material 1 filled in the cavity of the sidewall portions, and lowers thermal insulation performance (FIG. 12(B)). It is suitable that cavity 21c at the canopy portion is sloped inward toward the gap in the sidewall portion. The angle of the slope may be large enough to allow thermal insulation material 1 to move into the gap in the sidewall portion by its own weight.

Various applications can be expected for controlling thermal insulation performance. For example, the internal pressure of liquid hydrogen tanks used to supply hydrogen to fuel cell vehicles must be managed properly. If the internal pressure is too high, the tank needs to be vented to prevent it from rupturing, resulting in the waste of dumping hydrogen out of the container, while if the internal pressure is too low, the tank cannot be properly used to fill fuel cell vehicles with hydrogen. Similar internal pressure controls would be required for tanks of tankers transporting liquid hydrogen over long distances as well.

While the present invention made by the present inventors has been particularly described with respect to the embodiments thereof, the present invention is not limited thereto and other changes may be made therein without departing from the spirit and scope of the present invention.

### INDUSTRIAL APPLICABILITY

The present invention can be suitably used for a thermally insulation member capable of changing a location to be thermally insulated, and moreover, can be more suitably applied to a thermal insulation window that can switch between a transparent state and a light-shielding/heat-shielding state.

### EXPLANATION OF SIGN

1 Thermal insulation material
2 Liquid (water)
3 Compression mechanism
4 Lower elastic cavity
5 Upper elastic cavity
6 Frame
7 Panel
8 Space
10 Thermal insulation window
11 Primary particles
12 Secondary particles (aggregate of primary particles, cluster)
13 Aerogel particles (particles with framework formed by secondary particles)
14 Fine particles with framework formed by primary particles (e.g., TIISA)
20 Thermally insulated container
21 Cavity
21i, 21w, 21f, 21b Inner wall, outer wall, floor surface, bottom surface of thermally insulated container
21c Cavity in canopy portion of thermally insulated container
22 Gap (space)
23 Thermal insulation material storage
24 Liquid storage, volume control mechanism using liquid as medium
27 Outer cylinder
28 Piston
29 Control rod
90 Dynamic angle of repose measurement device
91 Sample
92 Glass container
93 Roller
96 Elastic tube
97 Compression block

1. A thermal insulation window comprising: a pair of panels; a space between the panels; a thermal insulation material to fill the space with; and a mechanism capable of moving the thermal insulation material into the space to fill it and removing the thermal insulation material from the space,
wherein the thermal insulation material is made of aerogel, which has a three-dimensional network structure whose framework is formed by a cluster, an aggregation of primary particles, and contains fine particles which have a three-dimensional network structure whose framework is formed by the primary particles.

2. The thermal insulation window according to claim 1, wherein 50% or more of the volume of the fine particles constituting the thermal insulation material is dispersed with a mode of particle size ranging from 0.1 μm or more to 1.0 μm or less.

3. The thermal insulation window according to claim 1, wherein the mechanism is capable of moving the liquid in contact with the thermal insulation material to move the thermal insulation material.

4. The thermal insulation window according to claim 3, wherein the thermal insulation material is hydrophobic and the liquid is water-based.

5. The thermal insulation window according to claim 3, wherein
the mechanism comprises an elastic cavity capable of accommodating the thermal insulation material and the liquid below the space, and a compression mechanism capable of increasing and reducing the volume of the elastic cavity; and
the mechanism moves the thermal insulation material from the elastic cavity into the space by reducing the volume of the elastic cavity with the compression mechanism, and moves the thermal insulation material from the space into the elastic cavity by increasing the volume of the elastic cavity with the compression mechanism.

6. The thermal insulation window according to claim 3, wherein
the mechanism comprises an upper elastic cavity capable of accommodating the thermal insulation material above the space, a lower elastic cavity capable of accommodating the liquid below the space, and a compression mechanism capable of increasing and reducing the volume of the lower elastic cavity, wherein
the mechanism moves the liquid from the elastic cavity into the space by reducing the volume of the lower elastic cavity with the compression mechanism and moves the thermal insulation material from the space to the upper elastic cavity, and
the mechanism moves the liquid from the space into the lower elastic cavity by increasing the volume of the lower elastic cavity with the compression mechanism and moves the thermal insulation material from the upper elastic cavity to the space.

7. A thermal insulation member comprising a shape-changing cavity and a thermal insulation material to be accommodated in the cavity, wherein the thermal insulation material is a powder and moves within the cavity as the shape is changed.

8. The thermal insulation member according to claim 7, wherein the thermal insulation material is made of aerogel, which has a three-dimensional network structure whose framework is formed by a cluster, an aggregation of primary particles, and contains fine particles which have a three-dimensional network structure whose framework is formed by the primary particles.

9. The thermal insulation member according to claim 7, wherein the thermal insulation material is flowable and has volume retention performance where the volume is retained before and after the change in cavity shape.

10. The thermal insulation member according to claim 7, wherein the inner pressure of the cavity is set lower than the external atmospheric pressure.

11. The thermal insulation member according to claim 7, wherein the cavity is filled with a gas of lower thermal conductivity than air.

12. The thermal insulation member according to claim 7, wherein the cavity further accommodates a liquid that is exclusive against the thermal insulation material.

13. The thermal insulation member according to claim 7, wherein the thermal insulation material is hydrophobic, and the cavity further accommodates water.

14. The thermal insulation member according to claim 7, wherein
the cavity comprises one or more pairs of panels and a thermal insulation material storage;
each of the one or more pairs of panels has a gap inside capable of accommodating the thermal insulation material; and
the thermal insulation material storage accommodates the thermal insulation material, and pushes the thermal insulation material into the gap between the panels or collects the thermal insulation material from the gap between the panels as a volume of a space that continues with the gap is changed.

15. The thermal insulation member according to claim 12, wherein
the cavity comprises one or more pairs of panels, a thermal insulation material storage, and a liquid storage;
each of the one or more pairs of panels has a gap inside capable of accommodating the thermal insulation material;
the thermal insulation material storage has a space continued with the gap and is capable of accommodating the thermal insulation material in the space; and
the liquid storage accommodates the liquid, and pushes the thermal insulation material into the gap between the panels or collects the thermal insulation material from the gap between the panels as a volume of the space that continues with the gap is changed to move the liquid.

16. The thermal insulation window according to claim 2, wherein the mechanism is capable of moving the liquid in contact with the thermal insulation material to move the thermal insulation material.

17. The thermal insulation window according to claim 16, wherein the thermal insulation material is hydrophobic and the liquid is water-based.

18. The thermal insulation window according to claim 16, wherein
the mechanism comprises an elastic cavity capable of accommodating the thermal insulation material and the liquid below the space, and a compression mechanism capable of increasing and reducing the volume of the elastic cavity; and
the mechanism moves the thermal insulation material from the elastic cavity into the space by reducing the volume of the elastic cavity with the compression mechanism, and moves the thermal insulation material from the space into the elastic cavity by increasing the volume of the elastic cavity with the compression mechanism.

19. The thermal insulation window according to claim 16, wherein
the mechanism comprises an upper elastic cavity capable of accommodating the thermal insulation material above the space, a lower elastic cavity capable of accommodating the liquid below the space, and a compression mechanism capable of increasing and reducing the volume of the lower elastic cavity, wherein
the mechanism moves the liquid from the elastic cavity into the space by reducing the volume of the lower elastic cavity with the compression mechanism and moves the thermal insulation material from the space to the upper elastic cavity, and
the mechanism moves the liquid from the space into the lower elastic cavity by increasing the volume of the lower elastic cavity with the compression mechanism and moves the thermal insulation material from the upper elastic cavity to the space.
